(19) United States
(12) Patent Application Publication
(10) Pub. No.: US 2010/0127934 A1
(43) Pub. Date: May 27, 2010

(54) POSITIONING SYSTEM, COMMUNICATION SIGNAL RECEIVER FOR POSITIONING SYSTEM, AND POSITION CALCULATION METHOD

(75) Inventors: Seung-il MYONG, Daejeon-si (KR); Sang-hyun MO, Daejeon-si (KR); Dong-beom SHIN, Daejeon-si (KR); Jae-heum LEE, Daejeon-si (KR); Heyung-sub LEE, Daejeon-si (KR); Jong-suk CHAE, Daejeon-si (KR)

Correspondence Address: Jae Y. Park, Kile, Goekjian, Reed & McManus, PLLC, 1200 New Hampshire Ave. NW, Suite 570, Washington, DC, 20036, US

(73) Assignee: Electronics and Telecommunications Research Institute, Daejeon-si (KR)

(21) Appl. No.: 12/580,310

(22) Filed: Oct. 16, 2009

(30) Foreign Application Priority Data
Nov. 26, 2008 (KR) 10-2008- 0118382

(51) Int. Cl. G01S 3/02

(52) U.S. Cl. 342/450

(57) ABSTRACT

A positioning system is provided which is capable of calculating the position of a target object even though it does not detect some synchronous signal necessary for position calculation. A communication signal receiver which provides information used in the position calculation is also provided. The positioning system includes a plurality of communication signal receivers each to detect a communication signal from a target object to be tracked and synchronous signals repeatedly transmitted for timing synchronization, and to acquire a receiving time interval between the synchronous signals, a receiving time interval between the synchronization signal and the communication signal, and synchronization signal identification information; and a position calculator to calculate a position of the target object by calculating a receiving time error of the communication signal from the receiving time interval between the synchronous signals, the receiving time interval between the synchronization signal and the communication signal, and the synchronization signal identification information.

### CROSS-REFERENCE TO RELATED APPLICATION

This application claims the benefit under 35 U.S.C. §119(a) of Korean Patent Application No. 10-2008-0118382, filed on Nov. 26, 2008, the disclosure of which is incorporated by reference in its entirety for all purposes.

### BACKGROUND

1. Field

The following description relates to a positioning system and, more particularly, to a positioning system capable of calculating the position of a target object even though it does not detect some synchronous signal necessary for position calculation, a communication signal receiver providing information used in the position calculation, and a method of the position calculation.

2. Description of the Related Art

A positioning system is a mechanism for determining the location of an object in space. The positioning system utilizes RFID (radio-frequency identification) or WLAN (wireless local area network) and may be used in many applications.

FIG. 1 is a diagram illustrating a positioning system using a reference point or a reference signal. In FIG. 1, reference numeral 10 denotes a common communication signal transmitter which is incorporated in a target object to be tracked and transmits a communication signal; reference numeral 12 denotes a synchronization signal transmitter which generates a synchronization signal for timing synchronization between the communication signal transmitter 10 and communication signal receivers 14 and 16. The communication signal receivers 14 and 16 each receive signals from the communication signal transmitter 10 and the synchronization signal transmitter 12 and send information about the receiving time of the signals to a position calculator 18. The position calculator 18 calculates the position of the target object. An increased number of the communication signal receivers may reduce an error in position calculation.

Problems with the conventional positioning system will now be described in detail with reference to FIG. 2. In FIG. 2, reference letters A, B, C, D, E and F each indicate the receiving time the synchronization signals are received by the communication signal receivers 14 and 16; reference letter H and I each indicate the receiving time the communication signals are received by the communication signal receivers 14 and 16.

It is assumed that the synchronization signals A, B and C are received by the communication signal receiver 14 and the synchronization signals D and F are received by the communication signal receiver 16. An error in receiving time between the signals received by the communication signal receivers 14 and 16 may be calculated from a difference in receiving time between the previous synchronization signals B and D and the communication signals H and I. Hence, reference letters ‘a’ and ‘b’ in FIG. 2 each indicate information about the time between the synchronization signals and the received communication signals. The time information is sent to the position calculator 18 to be used in calculating the position of the target object.

However, the time information about the signals received by the communication signal receiver 16 contains a significant error in time since the synchronization signal E has not been detected. This causes an imprecise calculation of the position of the communication signal transmitter 10. Accordingly, the positioning system has a problem in that the result of the position calculation may vary significantly depending on whether or not the communication signals and the synchronization signals are received.

### SUMMARY

Accordingly, in one aspect, there is provided a positioning system and method which is capable of calculating the position of a target object to be tracked by correcting an error in signal receiving time between two receivers regardless of whether or not some signal necessary for position calculation of the target object is detected.

Furthermore, in another aspect, there is provided a communication signal receiver which provides information necessary for calculating the position of the target object.

In one general aspect, there is provided a positioning system. The positioning system includes a plurality of communication signal receivers each to detect a communication signal from a target object to be tracked and synchronous signals repeatedly transmitted for timing synchronization, and to acquire a receiving time interval between the synchronous signals, a receiving time interval between the synchronization signal and the communication signal, and synchronization signal identification information; and a position calculator to calculate a position of the target object by calculating a receiving time error of the communication signal from the receiving time interval between the synchronous signals, the receiving time interval between the synchronization signal and the communication signal, and the synchronization signal identification information.

The communication signal receiver may include a synchronization signal detector to detect the synchronization signals repeatedly transmitted for timing synchronization and the synchronization signal identification information contained in the synchronization signal; a communication signal detector to detect the communication signal from the target object; a signal receiving time counter to count a receiving time interval T1 between the synchronization signals and a receiving time interval T2 between the synchronization signal and the communication signal; and an information transmitter to transmit the synchronization signal identification information and the receiving time intervals T1 and T2.

The synchronization signal identification information may include a number of transmitted synchronization signals or a transmitting time of the synchronization signal. The synchronization signal identification information may be inserted in a data segment in a synchronization signal frame including a preamble and the data segment.

In another general aspect, there is provided a method of calculating a position of a target object to be tracked by receiving a communication signal from the target object and a o synchronization signal from a synchronization signal transmitter.

The method includes acquiring synchronization signal identification information from synchronization signals received by each of different points, and calculating a receiving time interval between the synchronization signals received by the different points and a receiving time interval between the communication signal and the synchronization signal from which the is synchronization signal identification information is acquired; calculating a distance difference between two points by calculating a receiving time error, t1−t4, of signals received by the two points using the synchronization signal identification information, a receiving time interval, t3, between the synchronous signals, and receiving time intervals, t1 and t2, between the synchronization signal and the communication signal, which are acquired from the two points; and calculating the position of the target object by calculating a cross point of the distance difference between the two different points.

However, other features and aspects will be apparent from the following description, the drawings, and the claims.

### BRIEF DESCRIPTION OF THE DRAWINGS

FIG. 1 is a diagram illustrating a positioning system using a reference point or a reference signal.

FIG. 2 illustrates a timing diagram of a signal received by a communication signal receiver in FIG. 1.

FIG. 3 is a block diagram illustrating an exemplary communication signal receiver in FIG. 1.

FIG. 4 is a diagram illustrating an exemplary synchronization signal frame.

FIG. 5 is a flowchart illustrating an exemplary method of calculating a position of a target object.

FIG. 6 illustrates a timing diagram of a signal received by an exemplary communication signal receiver.

Throughout the drawings and the detailed description, unless otherwise described, the same drawing reference numbers refer to the same elements, features, and structures. The relative size and depiction of these elements may be exaggerated for clarity, illustration, and convenience.

### DETAILED DESCRIPTION

The detailed description is provided to assist the reader in gaining a comprehensive understanding of the methods, apparatuses and/or systems described herein. Accordingly, various changes, modifications, and equivalents of the systems, apparatuses, and/or methods described herein will be suggested to those of ordinary skill in the art. Also, descriptions of well-known functions and constructions are omitted to increase clarity and conciseness.

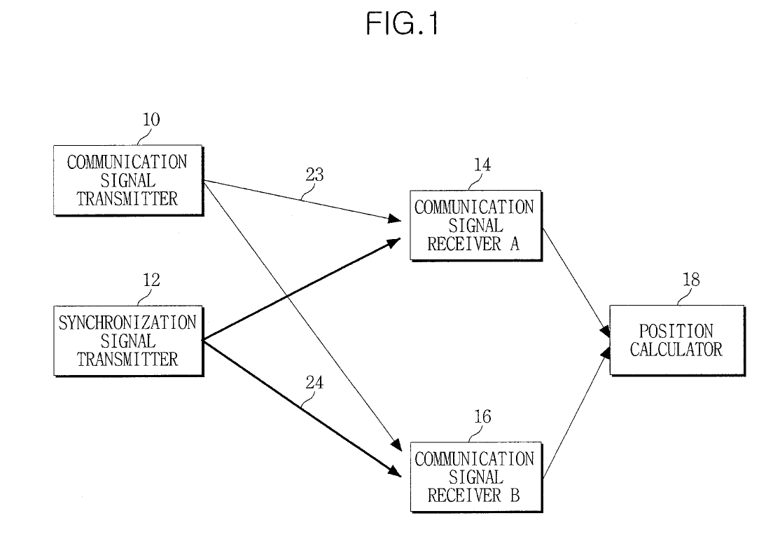

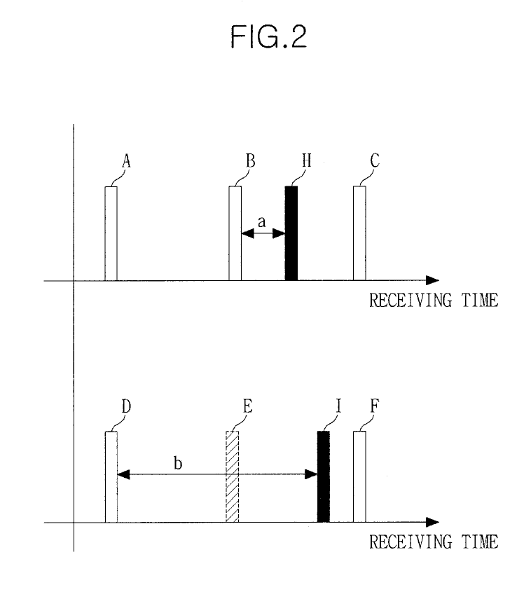

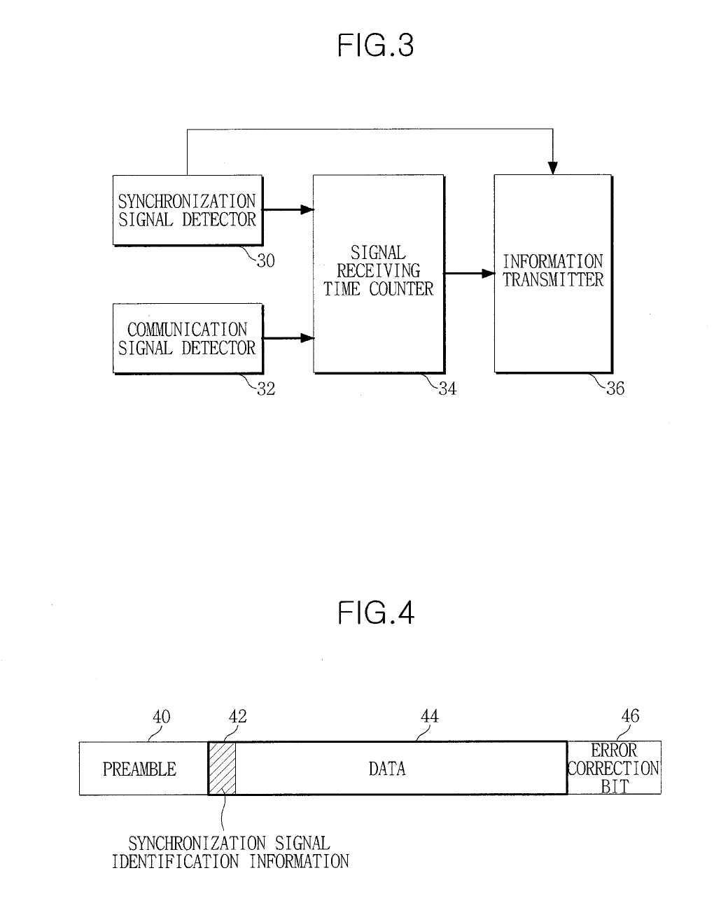

An exemplary positioning system includes a plurality of communication signal receivers and a position calculator as described above with reference to FIG. 1. However, unlike the conventional communication signal receivers shown in FIG. 1, the communication signal receivers in the exemplary positioning system each detect a communication signal from a target object to be tracked and synchronization signals repeatedly transmitted for timing synchronization, and acquire and transmit a receiving time interval between the received synchronization signals, a receiving time interval between the synchronization signal and the communication signal, and synchronization signal identification information to the position calculator. The configuration of the communication signal receiver will be described with reference to FIG. 3. The position calculator in the exemplary positioning system calculates the position of the target object by calculating an error in the receiving time of the communication signal from the receiving time interval between the received synchronization signals, the receiving time interval between the synchronization signal and the communication signal, and the synchronization signal identification information.

The communication signal receiver and the position calculator will now be described in detail with reference to the accompanying drawings.

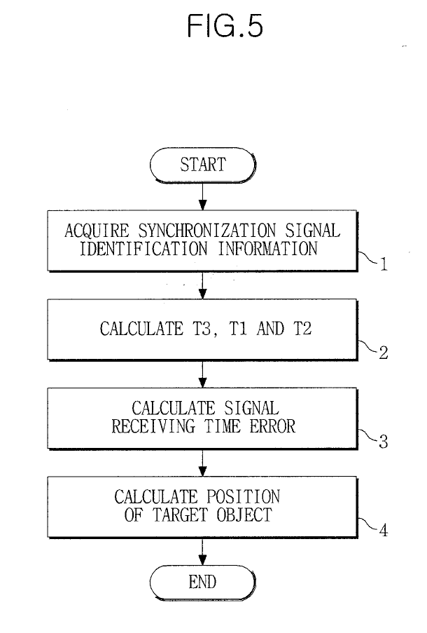

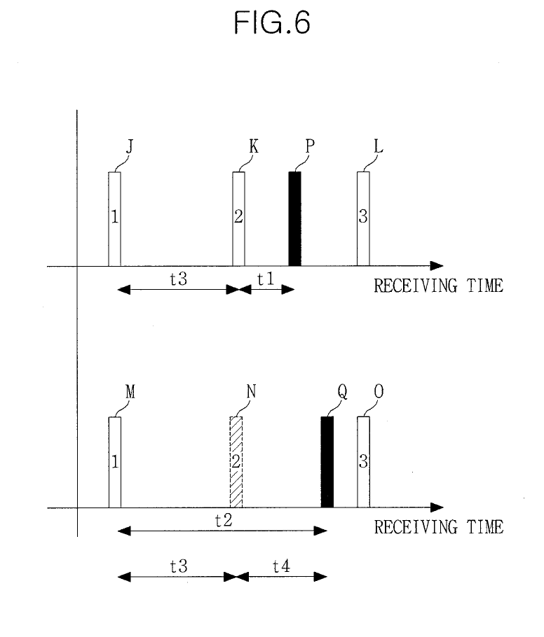

FIG. 3 is a block diagram illustrating an exemplary communication signal receiver. FIG. 4 is a diagram illustrating an exemplary synchronization signal frame. FIG. 5 is a flowchart illustrating an exemplary method of calculating a position. FIG. 6 illustrates a timing diagram of a signal received by an exemplary communication signal receiver.

Referring to FIG. 3, the communication signal receiver includes a synchronization signal detector 30, a communication signal detector 32, a signal receiving time counter 34, and an information transmitter 36. The synchronization signal detector 30 detects synchronization signals repeatedly transmitted for timing synchronization and synchronization signal identification information contained in the synchronization signal. The communication signal detector 32 detects a communication signal from a target object to be tracked. The signal receiving time counter 34 counts a receiving time interval between the synchronization signals, T1, and a receiving time interval between the synchronization signal and the communication signal, T2. The information transmitter 36 transmits the synchronization signal identification information and the receiving time intervals T1 and T2 to the position calculator.

The synchronization signal identification information, as shown in FIG. 4, is inserted in a synchronization signal frame containing a preamble 40, a data segment 44, and an error correction bit segment 46. More specifically, the synchronization signal identification information is inserted in the data segment. The synchronization signal identification information includes the number of transmitted synchronization signals (or the number of transmitted synchronization signal frames), issue of time (IOT) of a synchronization signal, or any other information about identification of the synchronization signal.

The communication signal receiver and the position calculator will now be described in detail with reference to FIGS. 3 to 6.

In FIG. 6, reference letters J, K, L, M and O indicate receiving times of synchronization signals which are received by the respective receivers and reference letters P and Q indicate receiving times of communication signals which are received by the respective receivers. Reference letter N indicates a receiving time of a synchronization signal which is not received by the receiver.

It is assumed that the synchronization signals are received at the receiving times J, K, L, M and O and the communication signals are received at the receiving times P and Q in such timing as shown in FIG. 6. In this case, the synchronization signal detector 30 acquires synchronization signal identification information included in the synchronization signals repeatedly transmitted for timing synchronization (operation 1) and sends the synchronization signal identification information to the information transmitter 36. In FIG. 6, reference numbers 1, 2 and 3 indicated in graphs of J, K, L, M and O denote first, second and third synchronization signal frames, respectively, as the synchronization signal identification information.

The synchronization signal detector 30 and the communication signal detector 32 in each of the two communication signal receivers may generate event signals indicating the synchronization signal receiving time and the communication signal receiving time, respectively, in such timing as shown in FIG. 6. The signal receiving time counters 34 calculates and outputs a receiving time interval between the synchronization signals, t3, and receiving time intervals between the synchronization signal and the communication signal, t1 and t2 according to the event signals (operation 2).

More specifically, if the synchronization signal detector 30 of one of the communication signal receivers receives the synchronization signals at the receiving times J, K and L and the communication signal detector 32 receives the communication signal at the receiving time P as shown in FIG. 6, the signal receiving time counter 34 sends the receiving time interval between the synchronization signals J and K, t3, and the receiving time interval between the synchronization signal K and the communication signal P, t1, to the information transmitter 36. On the other hand, if the synchronization signal detector 30 of the other communication signal receiver receives the synchronization signals at the receiving times M and O and the communication signal detector 32 receives the communication signal at the receiving time Q as shown in FIG. 6, the signal receiving time counter 34 sends the receiving time interval between the synchronization signals M and O, t2+n, and the receiving time interval between the synchronization signal M and the communication signal Q, t2, to the information transmitter 36.

The information transmitter 36, which is incorporated in each of the communication signal receivers, sends the receiving time intervals between the synchronization signals, t3 and t2+n, the receiving time intervals between the synchronization signal and the communication signal, t1 and t2, and the synchronization signal identification information, 1 and 2, to the position calculator according to a predetermined protocol. The synchronization signal identification information is identification information of the synchronization signal used in calculating the receiving time interval between the synchronization signal and the communication signal.

The position calculator acquires a receiving time interval between an imaginary synchronization signal and the communication signal, t4, by subtracting the receiving time interval between the synchronization signals, t3, acquired from one of the communication signal receivers (first point) from the receiving time interval between the synchronization signal and the communication signal, t2, acquired from the other communication signal receiver (second point). The position calculator calculates a receiving time error, t1−t4, of the communication signal by comparing the receiving time interval t4 with the receiving time interval, t1, acquired from the first communication signal receiver (operation 3). The position calculator calculates the position of the target object with no error (operation 4).

For reference, the method of calculating the position of the target object using the receiving time error will be additionally described. This method is referred to as TDOA (time difference of arrival) which uses a difference in signal receiving time between the communication signal receivers.

The position of a communication signal transmitter is a distance from each of the communication signal receivers. According to this method using the time difference, the position of the communication signal transmitter may be obtained from a difference in signal receiving time between signals received by two communication signal receivers, even though the communication signal receivers do not know the signal transmitting time of the communication signal transmitter.

For example, it is assumed that a distance between the communication signal transmitter 10 and the communication signal receiver 14 is L12 and a distance between the communication signal transmitter 10 and the communication signal receiver 16 is L13. The distance L12 is expressed as C (the speed of light)*A(transmitting time interval between the communication signal transmitter 10 and the communication signal receiver 14). The distance L13 is expressed as C (the speed of light)*B (transmitting time interval between the communication signal transmitter 10 and the communication signal receiver 16). If L12−L13 is dL (distance difference), the distance difference dL is expressed as follows:

dL=|L12−L13|=C|A−B|

In this equation, the transmitting time intervals A and B each indicate differences between a signal transmitting time of the communication signal transmitter 10 and a signal receiving time of each of the communication signal receivers 14 and 16.

The transmitting time intervals A and B are expressed as follows:

Transmitting time interval A=signal receiving time of communication signal receiver 14

signal transmitting time of communication signal transmitter 10;

Transmitting time interval B=signal receiving time of communication signal receiver 16

signal transmitting time of communication signal transmitter 10; thus

dL=C*|signal receiving time of communication signal receiver 14—signal receiving time of communication signal receiver 16|.

Therefore, in FIG. 6, the distance difference dL=C*(t1−t4).

Although this example describes a difference in signal receiving time between two communication signals, three or more communication signal receivers are needed to locate the position of a transmitting signal source. In this case, the position of the communication signal transmitter is calculated using a cross point of distance differences. That is, in case of three communication signal receivers a, b and c, the position of the communication signal transmitter is calculated using a cross point of dLab and dLbc.

As apparent from the above description, although any one of communication signal receivers in the positioning system does not receive some synchronization signal as a reference signal, the positioning system can calculate the position of a target object by correcting an error in receiving times of signals received by the communication signal receivers using synchronization signal identification information received by the other communication signal receiver.

A number of exemplary embodiments have been described above. Nevertheless, it will s be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A positioning system comprising:
a plurality of communication signal receivers each to detect a communication signal from a target object to be tracked and synchronous signals repeatedly transmitted for timing synchronization, and to acquire a receiving time interval between the synchronous signals, a receiving time interval between the synchronization signal and the communication signal, and synchronization signal identification information; and
a position calculator to calculate a position of the target object by calculating a receiving to time error of the communication signal from the receiving time interval between the synchronous signals, the receiving time interval between the synchronization signal and the communication signal, and the synchronization signal identification information.

2. The positioning system of claim 1, wherein the communication signal receiver comprises:
a synchronization signal detector to detect the synchronization signals repeatedly transmitted for timing synchronization and the synchronization signal identification information contained in the synchronization signal;
a communication signal detector to detect the communication signal from the target object;
a signal receiving time counter to count a receiving time interval T1 between the synchronization signals and a receiving time interval T2 between the synchronization signal and the communication signal; and
an information transmitter to transmit the synchronization signal identification information and the receiving time intervals T1 and T2.

3. The positioning system of claim 2, wherein the synchronization signal identification information comprises a number of transmitted synchronization signals or a transmitting time of the synchronization signal.

4. The positioning system of claim 3, wherein the synchronization signal identification information is inserted in a data segment in a synchronization signal frame including a preamble and the data segment.

5. The positioning system of claim 3, wherein the synchronization signal identification information is identification information of a synchronization signal used to calculate the receiving time interval between the synchronization signal and the communication signal.

6. The positioning system of claim 2, wherein the position calculator acquires a receiving time interval between an imaginary synchronization signal and a communication signal by subtracting a receiving time interval between synchronization signals acquired from a second communication signal receiver from a receiving time interval between a synchronization signal and a communication signal acquired from a first communication signal receiver, and compares the acquired receiving time interval between the imaginary synchronization signal and the communication signal with a receiving time interval between a synchronization signal and a communication signal acquired from the second communication receiver to calculate a receiving time error of the communication signal.

7. The positioning system of claim 1, wherein the synchronization signal identification information comprises a number of transmitted synchronization signal or a transmitting time of the synchronization signal.

8. The positioning system of claim 7, wherein the synchronization signal identification information is inserted in a data segment of a synchronization signal frame including a preamble and the data segment.

9. The positioning system of claim 8, wherein the synchronization signal identification information is identification information of the synchronization signal used to calculate the receiving time interval between the synchronization signal and the communication signal.

10. The positioning system of claim 1, wherein the position calculator acquires a receiving time interval between an imaginary synchronization signal and a communication signal by subtracting a receiving time interval between synchronization signals acquired from a second communication signal receiver from a receiving time interval between a synchronization signal and a communication signal acquired from a first communication signal receiver, and compares the acquired receiving time interval between the imaginary synchronization signal and the communication signal with a receiving time interval between a synchronization signal and a communication signal acquired from the second communication receiver to calculate a receiving time error of the communication signal.

11. A communication signal receiver for a positioning system, comprising:
a synchronization signal detector to detect synchronization signals repeatedly transmitted for timing synchronization and synchronization signal identification information;
a communication signal detector to detect a communication signal from a target object to be tracked;
a signal receiving time counter to count a receiving time interval T1 between the synchronization signals and a receiving time interval T2 between the synchronization signal and the communication signal; and
an information transmitter to transmit the synchronization signal identification information and the receiving time intervals T1 and T2 to an external device which calculates a position of the target object.

12. The communication signal receiver of claim 11, wherein the synchronization signal identification information comprises a number of transmitted synchronization signals or a transmitting time of the synchronization signal.

13. The communication signal receiver of claim 12, wherein the synchronization signal identification information is inserted in a data segment in a synchronization signal frame including a preamble and the data segment.

14. The communication signal receiver of claim 13, wherein the synchronization signal identification information is identification information of a synchronization signal used to calculate the receiving time interval between the synchronization signal and the communication signal.

15. The communication signal receiver of claim 11, wherein the synchronization signal identification information is inserted in a data segment in a synchronization signal frame including a preamble and the data segment.

16. The communication signal receiver of claim 15, wherein the synchronization signal identification information is identification information of a synchronization signal used to calculate the receiving time interval between the synchronization signal and the communication signal.

17. A method of calculating a position of a target object to be tracked by receiving a communication signal from the target object and a synchronization signal from a synchronization signal transmitter, the method comprising:
acquiring synchronization signal identification information from synchronization signals received by each of different points, and calculating a receiving time interval between the synchronization signals received by the different points and a receiving time interval between the communication signal and the synchronization signal from which the synchronization signal identification information is acquired;
calculating a distance difference between two points by calculating a receiving time error, t1−t4, of signals received by the two points using the synchronization signal identification information, a receiving time interval, t3, between the synchronous signals, and receiving time intervals, t1 and t2, between the synchronization signal and the communication signal, which are acquired from the two points; and
calculating the position of the target object by calculating a cross point of the distance difference between the two different points.

18. The method of claim 17, wherein the receiving time error, t1−t4, is calculated by, using as a reference signal a synchronous signal having the same identification information acquired by the two different points, subtracting a receiving time interval, t3, between synchronous signals acquired from a first point from a receiving time interval, t2, between a synchronous signal and a communication signal acquired from a second point to calculate a receiving time interval, t4 (=t2−t3), between an imaginary synchronous signal and the communication signal at the second point, and subtracting the calculated receiving time interval, t4, from the receiving time interval, t1, between the synchronous signal corresponding to the imaginary synchronous signal and the communication signal at the first point.
